(19) United States
(12) Patent Application Publication
(10) Pub. No.: US 2018/0336772 A1
(43) Pub. Date: Nov. 22, 2018

(54) SYSTEM AND METHOD FOR ALERTING A USER WITHIN A WAREHOUSE

(71) Applicant: HCL Technologies Limited, Noida (IN)

(72) Inventors: Madhusudhan RANJANGHATMURALIDHAR, Chennai (IN); Ashar PASHA, Dallas, TX (US)

(21) Appl. No.: 15/983,626

(22) Filed: May 18, 2018

(30) Foreign Application Priority Data
May 19, 2017 (IN) 201711017618

(51) Int. Cl. G08B 21/02; G08B 7/06; G06K 9/00

(52) U.S. Cl. CPC G08B 21/02; G08B 7/066; G06K 9/00604; G06K 9/00335; G06K 9/00771

(57) ABSTRACT

The present disclosure relates to system(s) and method(s) for alerting a user within a warehouse. The system is configured to receive a first video stream and a second video stream from a wearable device associated with the user in the warehouse. The first video stream may correspond to gaze data associated with the user, whereas, the second video stream corresponds to eye tracking data associated with the user. The system is configured to analyze the first video stream and second video stream to determine a current location of the user and activity being performed by the user, and user fatigue level. The system may further compute a location sensitivity based on comparison of the current location with a set of sensitive areas in the warehouse. The system may further transmit one or more alerts, to the wearable device, based on the user fatigue level, the activity and location sensitivity.

### CROSS-REFERENCE TO RELATED APPLICATIONS AND PRIORITY

The present application claims priority from Indian Patent Application No. 201711017618 filed on 19 May 2017 the entirety of which is hereby incorporated by reference

### TECHNICAL FIELD

The present disclosure in general relates to the field of real time assistance. More particularly, the present invention relates to a system and method for alerting a user within a warehouse.

### BACKGROUND

Nowadays, with the growth in mechanical industry a large number of factories are set up to meet the market requirement. Inventory management is one of the critical tasks faced by most of the mechanical industries. Currently, the mechanical industry is largely dependent on warehouses for inventory management. However, there are a lot of issues identified when it comes to inventory management in warehouses due to lack of real time information on flow of material.

Furthermore, in a closed working environment such a factory or warehouse, navigations systems such as Global Positioning System (GPS) are inadequate to guide a user in his day to day activities. GPS navigation is inefficient in indoor environment due to unavailability of wireless network inside the indoor environment. Lack of real time information about the current location of the user hinders effective decision making resulting in low customer satisfaction levels. Similar issues of slow and ineffective warehouse operations are faced across other industries.

To address this problem, augmented realty concept is widely used to help warehouse workers for pickups, returns, validation, order processing and shipping of goods bringing in significant efficiency gains. Further, augmented reality can also solve last-mile problems by ensuring the worker has the correct package and provide directions in real time to avoid any blocked routes. However, if the GPS navigation fails, the augmented realty based guiding system also fails.

### SUMMARY

This summary is provided to introduce aspects related to a system and method for alerting a user within a warehouse and the aspects are further described below in the detailed description. This summary is not intended to identify essential features of the claimed subject matter nor is it intended for use in determining or limiting the scope of the claimed subject matter.

In one embodiment, a method for alerting a user within a warehouse is illustrated. The method may comprise receiving, by a processor, a first video stream and a second video stream from a wearable device associated with a user in a warehouse. The first video stream corresponds to gaze data associated with the user, whereas the second video stream corresponds to eye tracking data associated with the user. The method may further comprise identifying, by the processor, a current location of the user based on analysis of the first video stream and a set of images associated with one or more locations within the warehouse. The method may further comprise computing, by the processor, a location sensitivity based on comparison of the current location with a set of sensitive areas in the warehouse. The method may further comprise identifying, by the processor, an activity being performed by the user based on analysis of the first video stream. The method may further comprise determining, by the processor, a user fatigue level based on analysis of the second video stream. The method may further comprise transmitting, by the processor, one or more alerts, to the wearable device, based on the user fatigue level, the activity and location sensitivity.

In another embodiment, a system for alerting a user within a warehouse is illustrated. The system comprises a memory and a processor coupled to the memory, further the processor may be configured to execute programmed instructions stored in the memory. In one embodiment, the processor may execute programmed instructions stored in the memory for receiving a first video stream and a second video stream from a wearable device associated with a user in a warehouse. The first video stream corresponds to gaze data associated with the user. Further, the second video stream corresponds to eye tracking data associated with the user. Further, the processor may execute programmed instructions stored in the memory for identifying a current location of the user based on analysis of the first video stream and a set of images associated with one or more locations within the warehouse. Further, the processor may execute programmed instructions stored in the memory for computing a location sensitivity based on comparison of the current location with a set of sensitive areas in the warehouse. Further, the processor may execute programmed instructions stored in the memory for identifying an activity being performed by the user based on analysis of the first video stream. Further, the processor may execute programmed instructions stored in the memory for determining a user fatigue level based on analysis of the second video stream. Further, the processor may execute programmed instructions stored in the memory for transmitting one or more alerts, to the wearable device, based on the user fatigue level, the activity and location sensitivity.

In yet another embodiment, a computer program product having embodied computer program for alerting a user within a warehouse is disclosed. The program may comprise a program code for receiving a first video stream and a second video stream from a wearable device associated with a user in a warehouse. The first video stream corresponds to gaze data associated with the user. Further, the second video stream corresponds to eye tracking data associated with the user. The program may comprise a program code for identifying a current location of the user based on analysis of the first video stream and a set of images associated with one or more locations within the warehouse. The program may comprise a program code for computing a location sensitivity based on comparison of the current location with a set of sensitive areas in the warehouse. The program may comprise a program code for identifying an activity being performed by the user based on analysis of the first video stream. The program may comprise a program code for determining a user fatigue level based on analysis of the second video stream. The program may comprise a program code for transmitting one or more alerts, to the wearable device, based on the user fatigue level, the activity and location sensitivity.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for alerting a user within a warehouse, in accordance with an embodiment of the present subject matter.

FIG. 2 illustrates the system for alerting a user within a warehouse, in accordance with an embodiment of the present subject matter.

FIG. 3 illustrates a method for alerting a user within a warehouse, in accordance with an embodiment of the present subject matter.

### DETAILED DESCRIPTION

Some embodiments of the present disclosure, illustrating all its features, will now be discussed in detail. The words “receiving”, “identifying”, “computing”, “determining”, “transmitting” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Various modifications to the embodiment will be readily apparent to those skilled in the art and the generic principles herein may be applied to other embodiments. However, one of ordinary skill in the art will readily recognize that the present disclosure for testing of the electronic device is not intended to be limited to the embodiments illustrated, but is to be accorded the widest scope consistent with the principles and features described herein.

The present subject matter relates to a system and method for alerting a user in a warehouse. The method may comprise steps for receiving a first video stream and a second video stream from a wearable device associated with a user in a warehouse. The first video stream may correspond to gaze data associated with the user, whereas, the second video stream corresponds to eye tracking data associated with the user. The method may further comprise steps for identifying a current location of the user based on analysis of the first video stream and a set of images associated with one or more locations within the warehouse. The method may further comprise steps for computing a location sensitivity based on comparison of the current location with a set of sensitive areas in the warehouse. The method may further comprise steps for identifying an activity being performed by the user based on analysis of the first video stream. The method may further comprise steps for determining a user fatigue level based on analysis of the second video stream. The method may further comprise steps for transmitting one or more alerts, to the wearable device, based on the user fatigue level, the activity and location sensitivity.

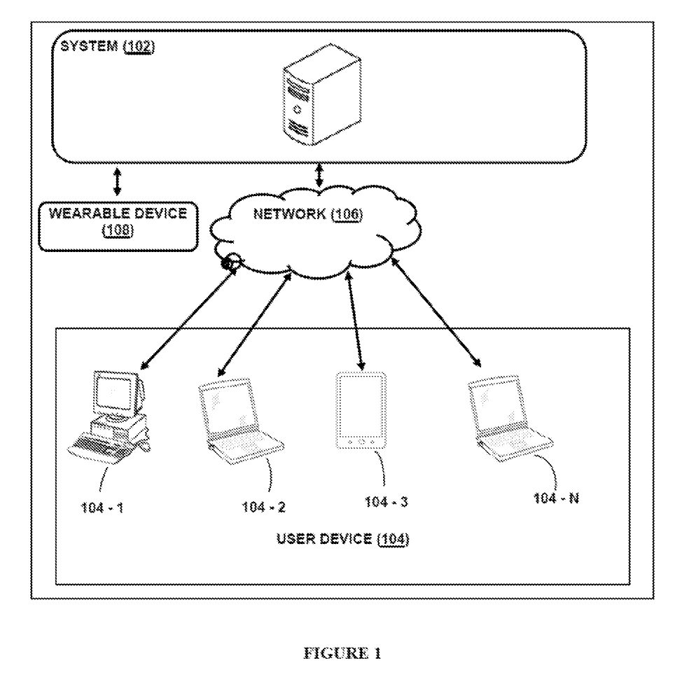

Referring now to FIG. 1, a network implementation 100 of a system 102 for alerting a user within a warehouse is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106. Further, the system 102 may be communicatively coupled with the wearable device 108. The wearable device 108 may be enabled with a primary camera and a secondary camera. The primary camera maybe focused away from the user eyes and the secondary camera may be focused on the user eyes. The primary camera of the wearable device is configured to capture a first video stream and the secondary camera of the wearable device is configured to capture a second video stream.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

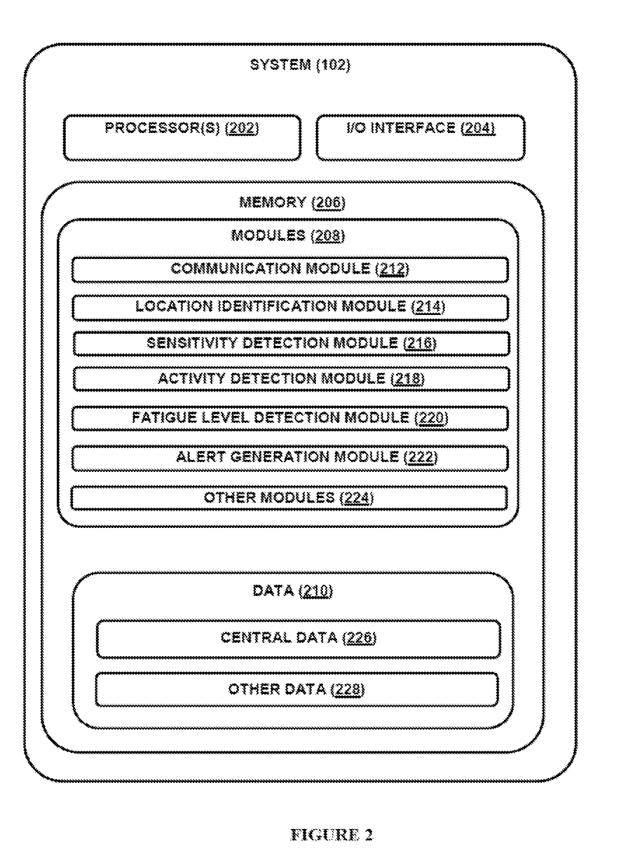

In one implementation, the wearable device 108 may be a separate device such as a smart glass, or a head mounted camera system. The wearable device 108 may be configured to capture a first video stream and a second video stream. The first video stream is captured by a primary camera of the wearable device and the second video stream is captured by a secondary camera of the wearable device. The first video stream corresponds to gaze data associated with the user. The second video stream corresponds to eye tracking data associated with the user. The wearable device 108 may be configured to determine current location based on video stream captured by the primary camera in the wearable device 108. One the current location is identified, the system 102 is configured to determine location sensitivity based on comparison of the current location with the set of sensitive areas in the warehouse. Further, the system 102 is configured to identify an activity being performed by the user based on analysis of the first video stream. Further, the system 102 may determine a user fatigue level based on analysis of the second video stream. Furthermore, one or more alerts may be transmitted to the wearable device 108 based on the user fatigue level, the activity and location sensitivity. The system 102 for alerting the user in a warehouse is further elaborated with respect to the FIG. 2.

Referring now to FIG. 2, the system 102 for alerting a user in a warehouse is illustrated in accordance with an embodiment of the present subject matter. In one embodiment, the system 102 may be configured to communicate with a wearable device 108. The system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a communication module 212, a location identification module 214, a sensitivity detection module 216, a activity detection module 218, a fatigue level detection module 220, an alert generation module 222 and other modules 224. The other modules 224 may include programs or coded instructions that supplement applications and functions of the system 102.

The data 210, amongst other things, serve as a repository for storing data processed, received, and generated by one or more of the modules 208. The data 210 may also include a central data 226, and other data 228. In one embodiment, the other data 228 may include data generated as a result of the execution of one or more modules in the other module 224.

In one implementation, a user may access the system 102 via the I/O interface 204. The user may be registered using the I/O interface 204 in order to use the system 102. In one aspect, the user may access the I/O interface 204 of the system 102 for obtaining information, providing inputs or configuring the system 102.

In one embodiment, the communication module 212 may be configured to receive a first video stream and a second video stream from the wearable device 108 associated with a user in a warehouse. The wearable device 108 may be a separate device such as a smart glass, an Augmented Reality (AR) glasses, or a head mounted camera system. The wearable device 108 may be configured to capture a first video stream and a second video stream. The first video stream is captured by a primary camera of the wearable device and the second video stream is captured by a secondary camera of the wearable device. The first video stream corresponds to gaze data associated with the user. The second video stream corresponds to eye tracking data associated with the user. The gaze data may include images of the area surrounding the user. The eye tracking data may include images of user eye movement.

In one embodiment, the location identification module 214 may be configured to identify a current location of the user based on analysis of the first video stream and a set of images associated with one or more locations within the warehouse. In one embodiment, the location identification module 214 may enable one or more image recognition algorithms for identifying one or more landmarks in the first video stream. Once the landmarks are identified, the current location of the user may be determined based on the proximity of the user to the one or more landmarks.

In one embodiment, the sensitivity detection module 216 is configured to compute a location sensitivity based on comparison of the current location with the set of sensitive areas. The sensitive areas may be predefined areas in the warehouse. The location sensitivity may correspond to an immediate threat to the user determined based on distance between the current location of the user and each sensitive area from the set of sensitive areas.

Further, the activity detection module 218 may be configured to identify an activity being performed by the user based on analysis of the first video stream. The activity may be determined using the image processing algorithms enabled at the system 102. For example, the user may be driving a forklift, or operating a CNC machine. The activity is determined by detecting the hand movement of the user.

Further, the Fatigue level detection module 220 is configured to determine a user fatigue level based on analysis of the second video stream. The user fatigue level may correspond to drowsiness, sleepiness, inattentiveness, and a like the user. In one embodiment, one or more video stream analysis algorithms may be implemented in order to determine a user fatigue level of the user.

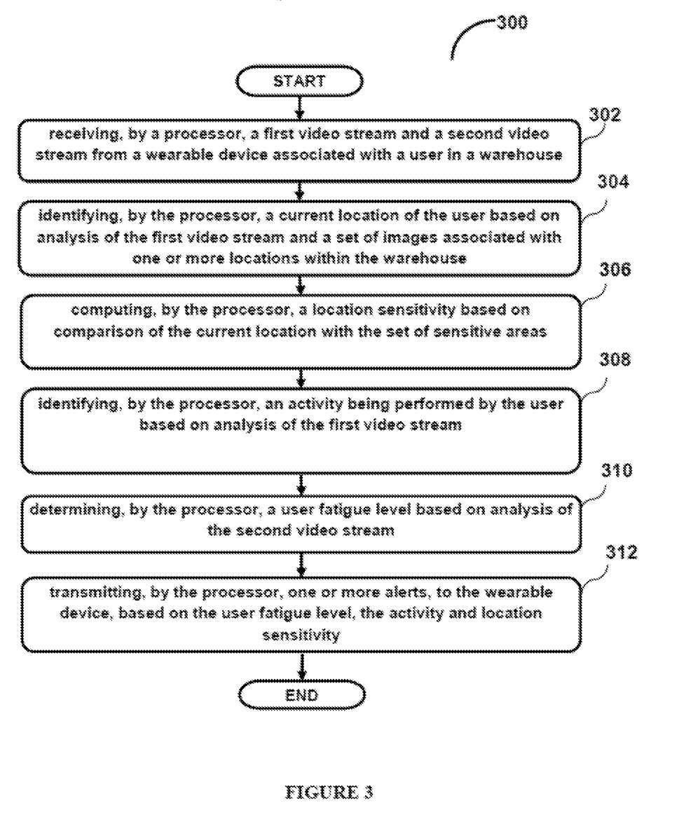

Finally, the alert generation module 222 is configured to generate and transmit one or more alerts, to the wearable device 108, based on the user fatigue level, the activity and location sensitivity. The alerts may be configured to warn the user of the immediate threats in his vicinity. The alert generation module 222 may further enable guiding the user to reach a destination location in the warehouse based on analysis of the second set of video frames. Further, the method for alerting a user in a warehouse is elaborated with respect to the block diagram of FIG. 3.

Referring now to FIG. 3, a method 300 for alerting a user in a warehouse, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the communication module 212 may be configured to receive a first video stream and a second video stream from the wearable device 108 associated with a user in a warehouse. The wearable device 108 may be a separate device such as a smart glass, an Augmented Reality (AR) glasses, or a head mounted camera system. The wearable device 108 may be configured to capture a first video stream and a second video stream. The first video stream is captured by a primary camera of the wearable device and the second video stream is captured by a secondary camera of the wearable device. The first video stream corresponds to gaze data associated with the user. The second video stream corresponds to eye tracking data associated with the user. The gaze data may include images of the area surrounding the user. The eye tracking data may include images of user eye movement.

At block 304, the location identification module 214 may be configured to identify a current location of the user based on analysis of the first video stream and a set of images associated with one or more locations within the warehouse. In one embodiment, the location identification module 214 may enable one or more image recognition algorithms for identifying one or more landmarks in the first video stream. Once the landmarks are identified, the current location of the user may be determined based on the proximity of the user to the one or more landmarks.

At block 306, the sensitivity detection module 216 is configured to compute a location sensitivity based on comparison of the current location with the set of sensitive areas. The sensitive areas may be predefined areas in the warehouse. The location sensitivity may correspond to an immediate threat to the user determined based on distance between the current location of the user and each sensitive area from the set of sensitive areas.

At block 308, the activity detection module 218 may be configured to identify an activity being performed by the user based on analysis of the first video stream. The activity may be determined using the image processing algorithms enabled at the system 102. For example, the user may be driving a forklift, or operating a CNC machine. The activity is determined by detecting the hand movement of the user.

At block 310, the Fatigue level detection module 220 is configured to determine a user fatigue level based on analysis of the second video stream. The user fatigue level may correspond to drowsiness, sleepiness, inattentiveness, and a like the user. In one embodiment, one or more video stream analysis algorithms may be implemented in order to determine a user fatigue level of the user.

At block 312, the alert generation module 222 is configured to generate and transmit one or more alerts, to the wearable device 108, based on the user fatigue level, the activity and location sensitivity. The alerts may be configured to warn the user of the immediate threats in his vicinity. The alert generation module 222 may further enable guiding the user to reach a destination location in the warehouse based on analysis of the second set of video frames.

Although implementations for systems and methods for alerting a user within a warehouse have been described, it is to be understood that the appended claims are not necessarily limited to the specific features or methods described. Rather, the specific features and methods are disclosed as examples of implementations for alerting a user.

We claim:

1. A method for alerting a user within a warehouse, the method comprises steps of:
receiving, by a processor, a first video stream and a second video stream from a wearable device associated with a user in a warehouse, wherein the first video stream corresponds to gaze data associated with the user, and wherein the second video stream corresponds to eye tracking data associated with the user;
identifying, by the processor, a current location of the user based on analysis of the first video stream and a set of images associated with one or more locations within the warehouse;
computing, by the processor, a location sensitivity based on comparison of the current location with a set of sensitive areas in the warehouse;
identifying, by the processor, an activity being performed by the user based on analysis of the first video stream;
determining, by the processor, a user fatigue level based on analysis of the second video stream; and
transmitting, by the processor, one or more alerts, to the wearable device, based on the user fatigue level, the activity and location sensitivity.

2. The method of claim 1, wherein the first video stream is captured by a primary camera of the wearable device, wherein the second video stream is captured by a secondary camera of the wearable device, wherein the primary camera is focused away from the user eyes, and wherein the secondary camera is focused on the user eyes.

3. The method of claim 1, wherein the location sensitivity corresponds to an immediate threat to the user determined based on distance between the current location of the user and each sensitive area from the set of sensitive areas.

4. The method of claim 1, further comprises steps for guiding the user to reach a destination location in the warehouse based on analysis of the second set of video frames.

5. A system for alerting a user within a warehouse, the system comprising:
a memory; and
a processor coupled to the memory, wherein the processor is configured to execute programmed instructions stored in the memory for:
receiving a first video stream and a second video stream from a wearable device associated with a user in a warehouse, wherein the first video stream corresponds to gaze data associated with the user, and wherein the second video stream corresponds to eye tracking data associated with the user;
identifying a current location of the user based on analysis of the first video stream and a set of images associated with one or more locations within the warehouse;
computing a location sensitivity based on comparison of the current location with a set of sensitive areas in the warehouse;
identifying an activity being performed by the user based on analysis of the first video stream;
determining a user fatigue level based on analysis of the second video stream; and
transmitting one or more alerts, to the wearable device, based on the user fatigue level, the activity and location sensitivity.

6. The system of claim 5, wherein the first video stream is captured by a primary camera of the wearable device, wherein the second video stream is captured by a secondary camera of the wearable device, wherein the primary camera is focused away from the user eyes, and wherein the secondary camera is focused on the user eyes.

7. The system of claim 5, wherein the location sensitivity corresponds to an immediate threat to the user determined based on distance between the current location of the user and each sensitive area from the set of sensitive areas.

8. The system of claim 5 further configured for guiding the user to reach a destination location in the warehouse based on analysis of the second set of video frames.

9. A computer program product having embodied thereon a computer program for alerting a user within a warehouse, the computer program product comprising:
a program code for receiving a first video stream and a second video stream from a wearable device associated with a user in a warehouse, wherein the first video stream corresponds to gaze data associated with the user, and wherein the second video stream corresponds to eye tracking data associated with the user;
a program code for identifying a current location of the user based on analysis of the first video stream and a set of images associated with one or more locations within the warehouse;
a program code for computing a location sensitivity based on comparison of the current location with a set of sensitive areas in the warehouse;
a program code for identifying an activity being performed by the user based on analysis of the first video stream;
a program code for determining a user fatigue level based on analysis of the second video stream; and
a program code for transmitting one or more alerts, to the wearable device, based on the user fatigue level, the activity and location sensitivity.
